(19) United States
(12) Patent Application Publication
(10) Pub. No.: US 2024/0212059 A1
(43) Pub. Date: Jun. 27, 2024

(54) ENHANCED AUTOMATED ENTITY CLOSE PROCESS MANAGEMENT

(71) Applicant: SAP SE, Walldorf (DK)

(72) Inventor: Thomas Luecking, Bruchsal (DE)

(73) Assignee: SAP SE, Walldorf (DE)

(21) Appl. No.: 18/088,339

(22) Filed: Dec. 23, 2022

(51) Int. Cl. G06Q 40/12; G06Q 10/0631; G06Q 10/067

(52) U.S. Cl. CPC G06Q 40/12; G06Q 10/06316; G06Q 10/067

(57) ABSTRACT

A computer implement method can present, on a display window, an entity close scheme including a plurality of task sequences, wherein a task sequence includes one or more task objects with respective start times and durations. On the display window, the method can mark a closing target time for the entity close scheme, highlight target critical sequences from the plurality of task sequences based on the closing target time and a predefined offset duration, and highlight a longest sequence from the plurality of task sequences based on the start times and durations of the task objects included in the plurality of task sequences. The method can simulate, through a user interface, a change to the entity close scheme. Responsive to the simulated change, the method can update the target critical sequences and the longest sequence on the display window.

### BACKGROUND

A number of advances have been made in the field of automated accounting. Huge volumes of data are now easily stored and manipulated. As part of the automated process, an entity may be required to provide a set of transactional statements along with accompanying documentations for each accounting cycle defined by a reporting key date. An “entity close” is a broad term that involves executing a series of interrelated and/or interdependent accounting tasks during the accounting cycle, with the ultimate goal of generating internal and external financial reports. The faster the entity close can be completed, the earlier key stakeholders can receive operational insights, based on which strategic organizational decisions can be timely made. However, despite huge investments in enterprise resource planning (ERP) applications, many organizations still struggle with the automated entity close process, which can take days, weeks, or even months longer than planned to complete. Accordingly, room for improvement exists for developing advanced tools to plan, execute, monitor, and control the entire entity close cycle more efficiently.

### BRIEF DESCRIPTION OF THE DRA WINGS

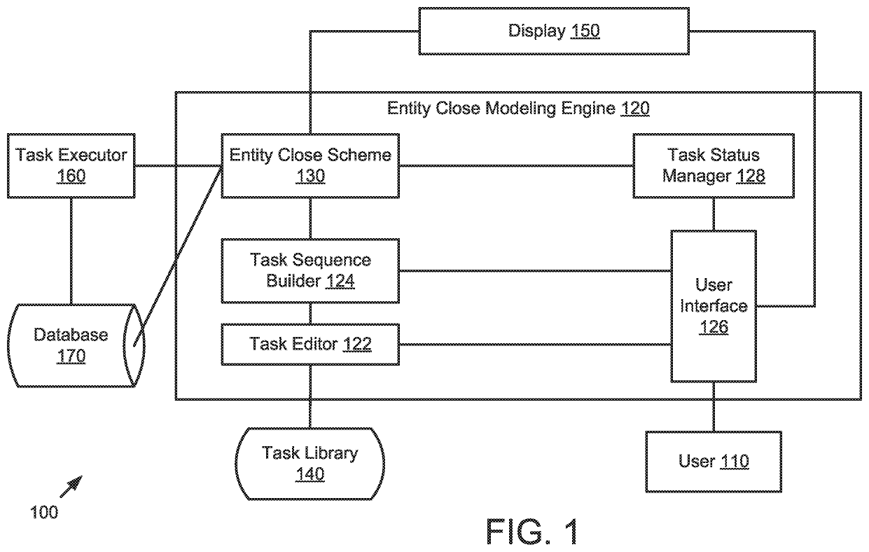

FIG. 1 is an overall block diagram of an example system supporting enhanced automated entity close process management.

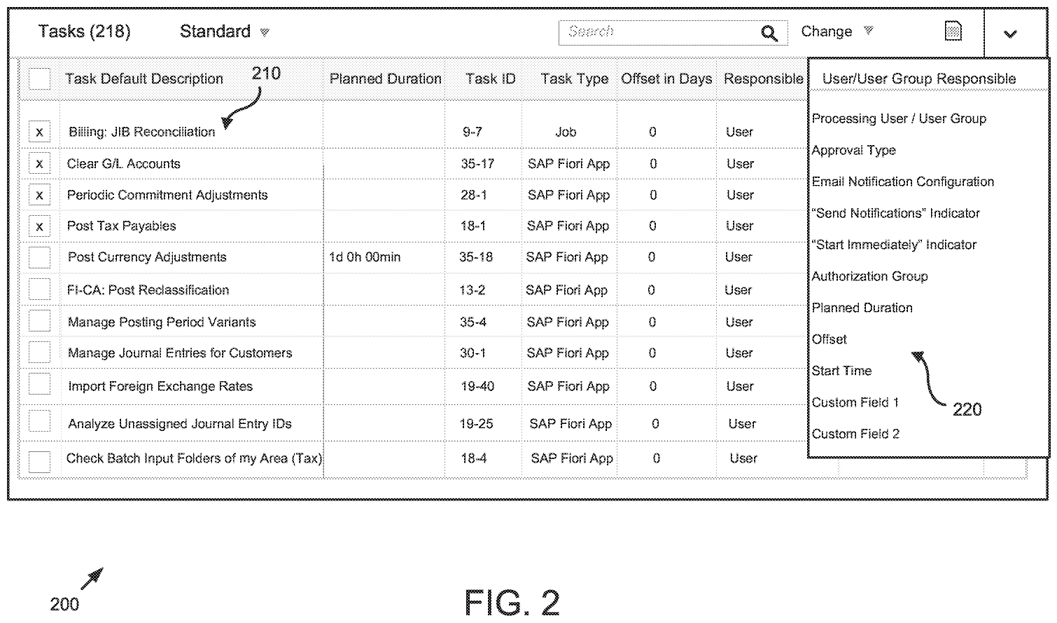

FIG. 2 is an example user interface through which a user can change properties of selected task objects.

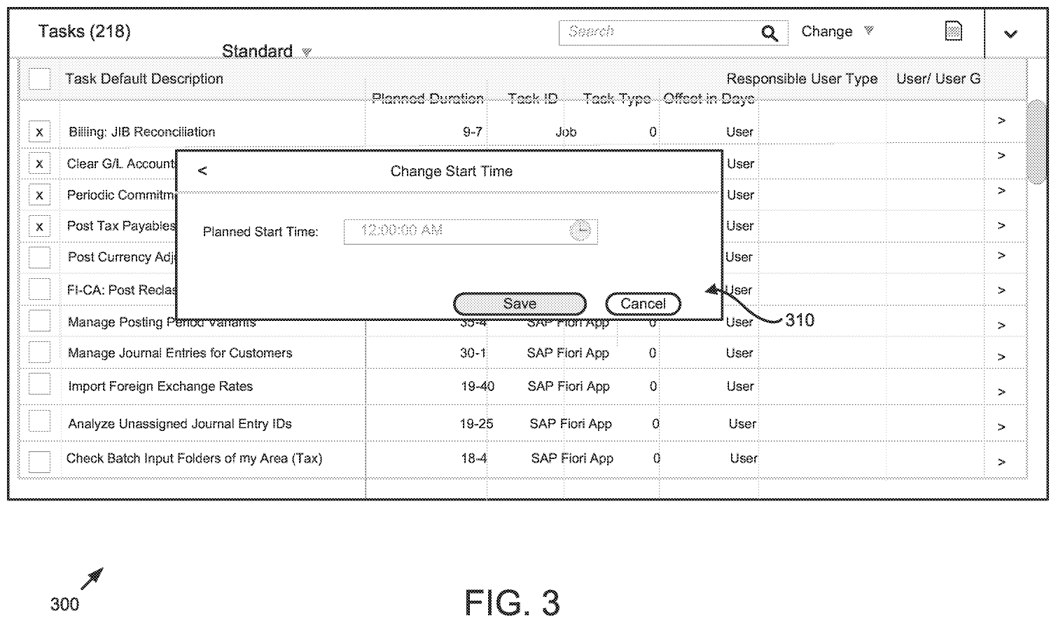

FIG. 3 illustrates changing start times of task objects selected through the user interface of FIG. 2.

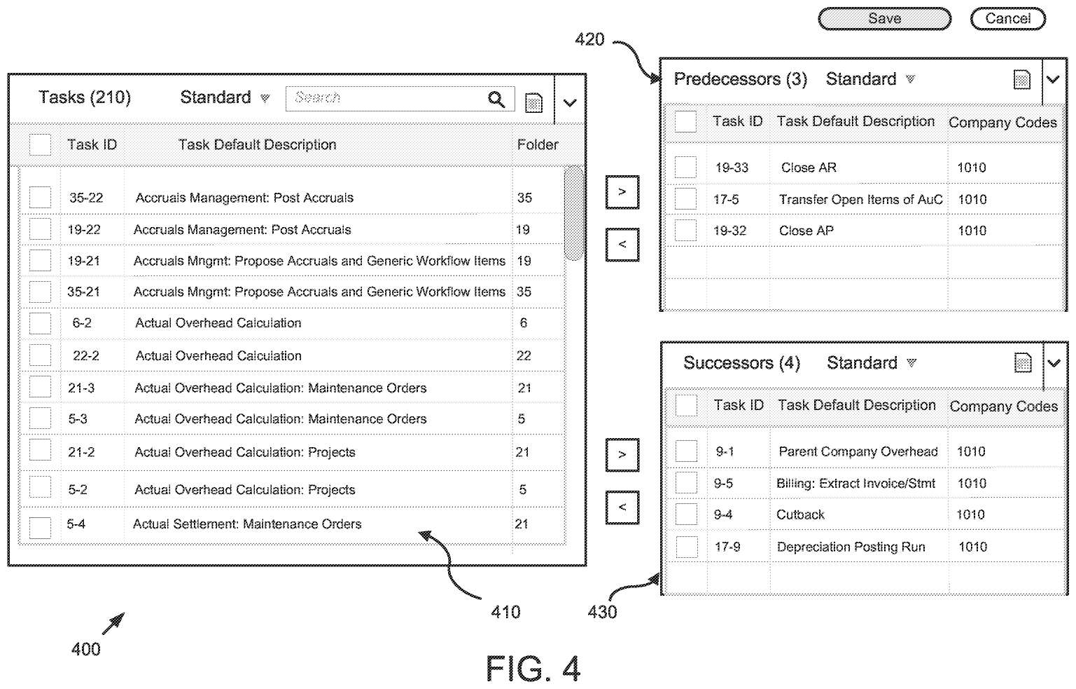

FIG. 4 is an example user interface through which a user can define dependencies between task objects.

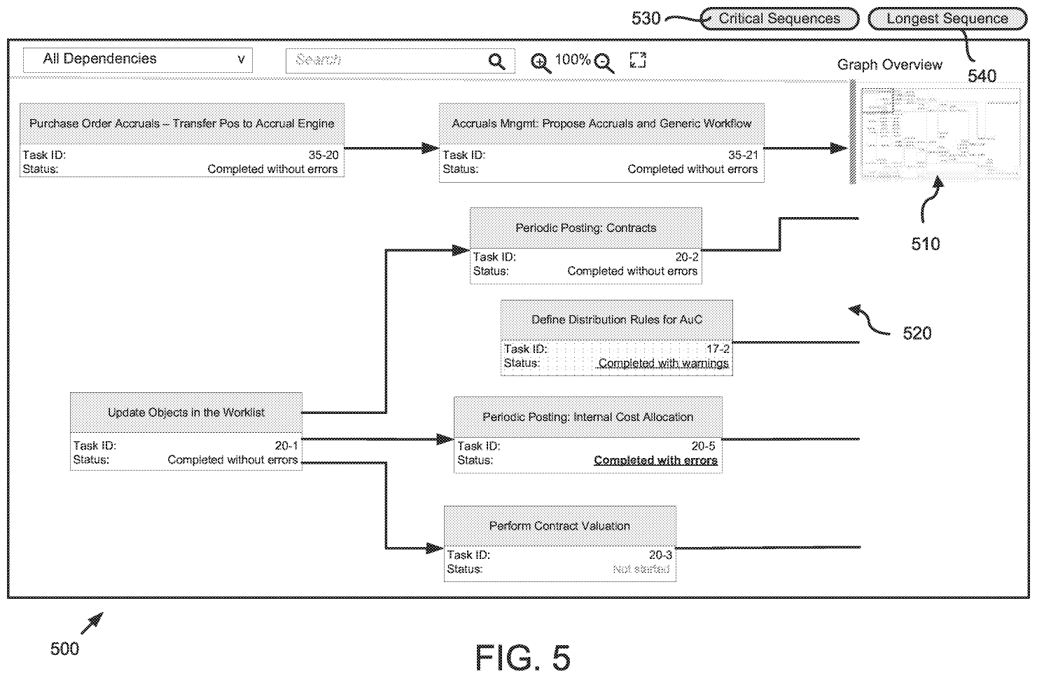

FIG. 5 is an example display window which graphically depicts an example entity close scheme.

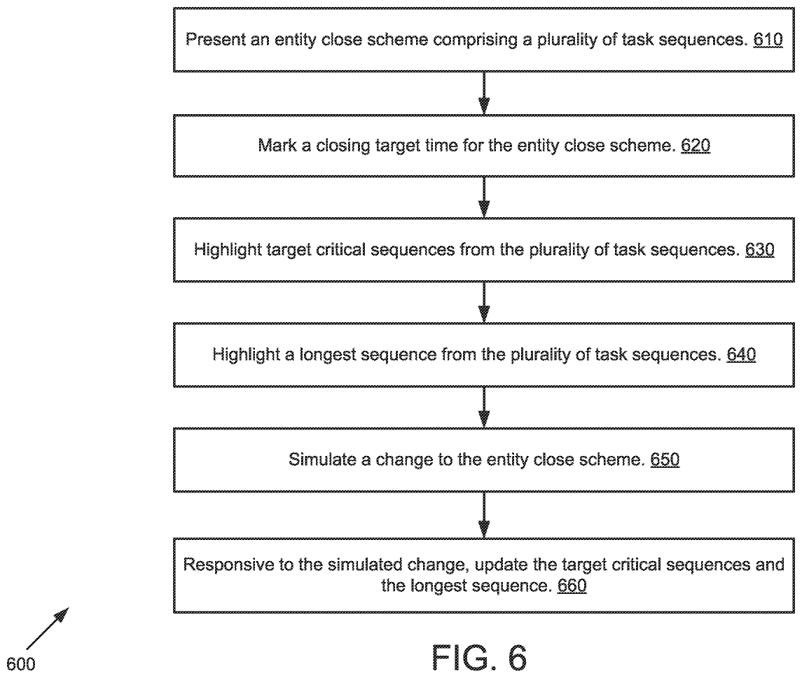

FIG. 6 is a flowchart illustrating an example overall method of implementing enhanced automated entity close process.

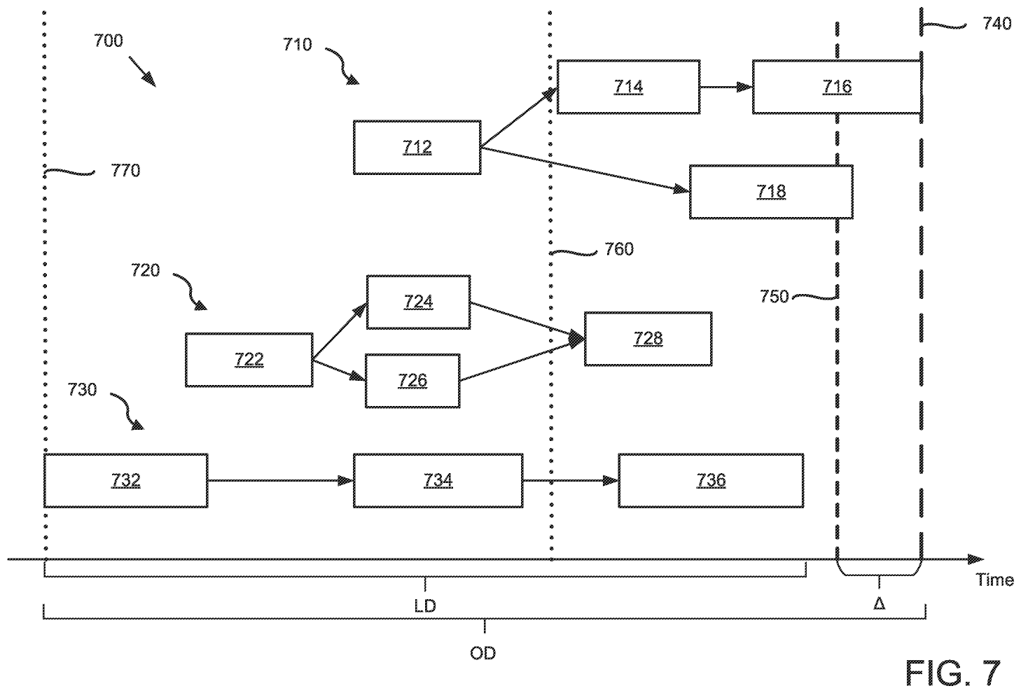

FIG. 7 schematically depicts an example entity close scheme including a plurality of task objects and associated time points.

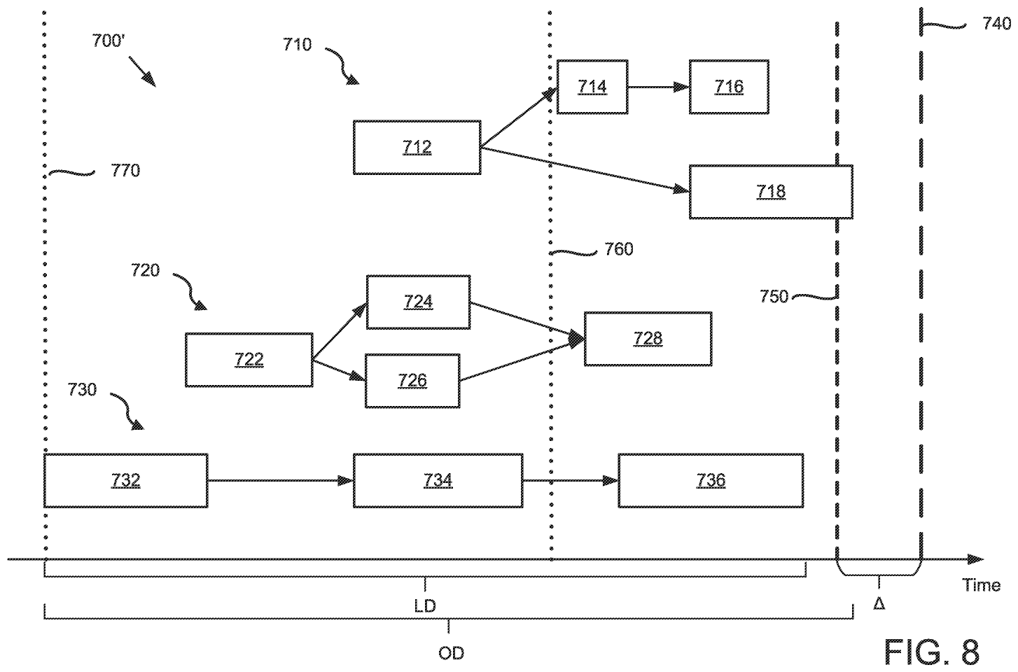

FIG. 8 schematically depicts an updated entity close scheme based on simulated changes to certain task objects of FIG. 7.

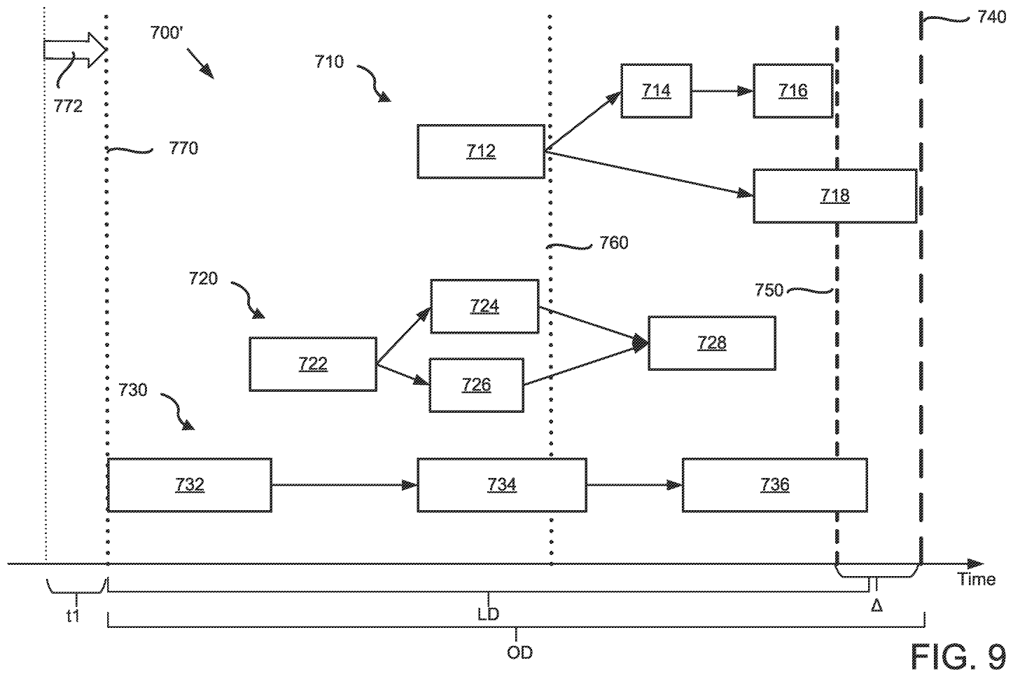

FIG. 9 schematically depicts one option to reduce the overall duration of the entity close scheme of FIG. 8.

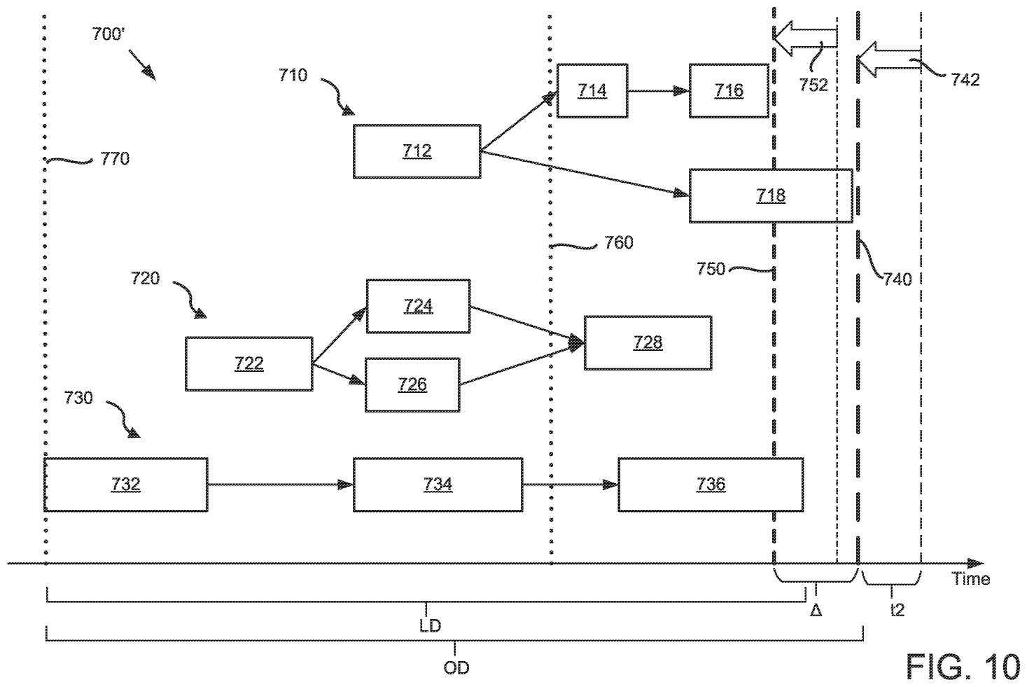

FIG. 10 schematically depicts another option to reduce the overall duration of the entity close scheme of FIG. 8.

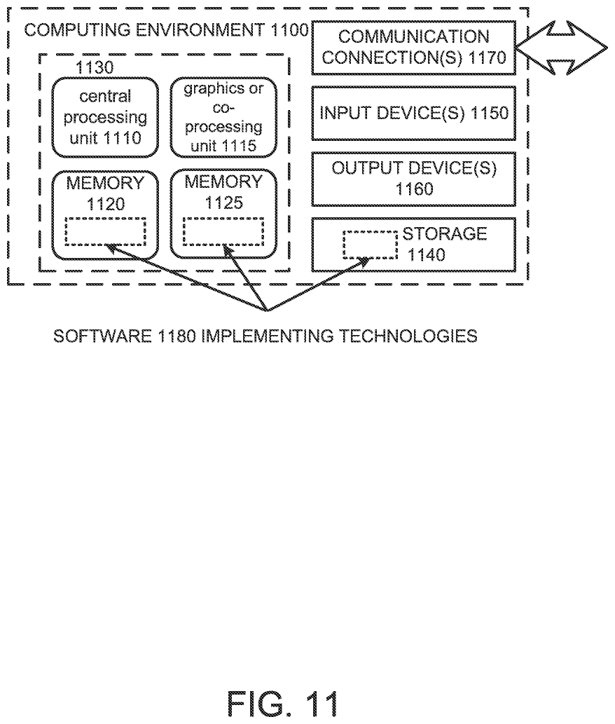

FIG. 11 is a block diagram of an example computing system in which described embodiments can be implemented.

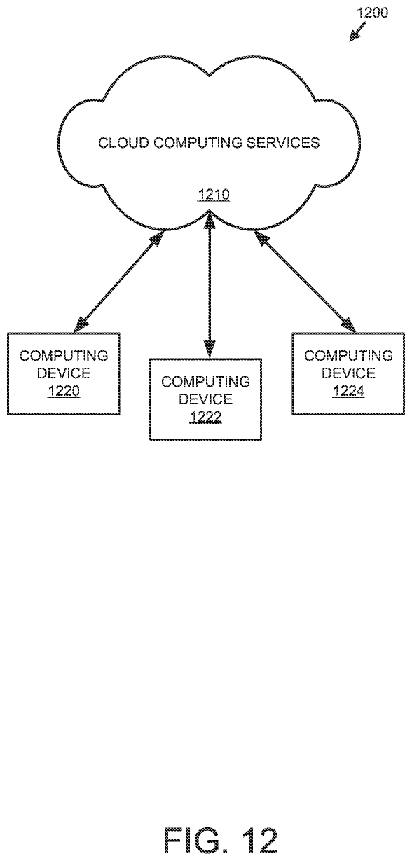

FIG. 12 is a block diagram of an example cloud computing environment that can be used in conjunction with the technologies described herein.

### DETAILED DESCRIPTION

### Example 1—Overview of Automated Entity Closing Process

A typical automated entity close process can involve numerous tasks (also referred to as “task objects”), which must be performed efficiently, collaboratively, and accurately before accountants can close the books on the current accounting period. The automated entity close process can have a planning phase and an execution phase. In the planning phase, the involved tasks are scheduled. In the execution phase, these tasks are executed according to the schedule. The actual execution of the tasks can be manual, semi-automatic, and/or automatic.

In planning the automated entity close, each task can be specified with a planned start time and duration, among other attributes or parameters. Additionally, dependencies between the tasks need to be defined. For example, some of the tasks must be performed sequentially. Such sequential tasks can thus form a task sequence in which the start of a successor task depends on the completion of a predecessor task. As another example, some of the tasks have to be performed in parallel, thus forming a plural of task sequences. While some of the task sequences may be independent from each other, some of the task sequences can comprise sub-sequences, thereby creating dependencies therebetween.

These tasks and their inter-relationship, collectively, can be called an entity close scheme (which can also be referred to as a schedule or timetable for the entity close). In some examples, the entity close scheme can be graphically represented so as to provide a user (e.g., an accountant, etc.) a visual display of different tasks involved in the entity close and their interrelationship.

Regardless of an organization's size or financial sophistication, the automated entity close process can be extremely convoluted. For instance, a typical entity close scheme can involve hundreds or thousands of tasks organized in dozens of task sequences, and many task sequences can include two or more subsequences. Such complicated entity close scheme can be overwhelming to users, who can get frustrated by the complex task relationship.

For example, although theoretically there may be room to reduce the overall duration (i.e., overall execution time) of the entity close scheme, e.g., by changing the timing parameters of certain tasks, the users may not identify such opportunities simply because these tasks are easily overlooked in the convoluted entity close scheme. As described herein, the overall duration of an entity close scheme refers to the duration starting from the earliest start time among all tasks to the latest completion time among all tasks involved in the entity close scheme. Some existing entity close software applications can identify a so-called critical path, which refers to a task sequence in which the total durations of all involved tasks is the longest among all task sequences. Such metric, however, may not be helpful in reducing the overall duration of the entity close scheme partially because it fails to consider the possible time gaps between the tasks.

As another example, during the automated entity close process, actual execution of certain tasks often deviates from what has been planned. Some deviation can be positive (e.g., task is completed earlier than what was planned) or negative (e.g., task is completed later than what was planned). Positive deviations may represent opportunities to shorten the overall duration of entity close, whereas negative deviations may pose a risk of delay to the entity close. However, the complex entity close scheme may make it difficult for the users to investigate and evaluate the effects of these deviations on the overall entity close duration, thus either forfeiting the opportunities and/or causing undesirable delays in entity close.

The technologies described herein provides a computing system which allows users to perform enhanced automated entity close process management. Specifically, the enhanced automated entity close process management system described herein provides a tool which enables the users to optimize an automated entity close process on the fly (e.g., during planning as well as execution of the tasks), and modify the entity close scheme as necessary to avoid delays upon detection of negative deviations when executing certain tasks.

As described herein, optimization of an automated entity close process refers to making changes to the entity close scheme underlying the automated entity close process to reduce its overall duration. Such optimization can also take into account a prespecified deadline so as to ensure the entity close is completed before the deadline. In practice, although the terms “optimal” and “optimize” are used, the shortest possible overall duration of the entity close scheme may not be achieved, but the achieved overall duration of the entity close scheme is shorter than otherwise not making those changes.

Although the examples described below are related to entity close, it is to be understood that the technologies disclosed herein can be used in other applications. For example, the computing system and software tools incorporating the disclosed technologies can be used for project planning/monitoring where a project schedule or scheme involves a plurality of tasks organized in a plurality of task sequences.

### Example 2—Example Enhanced Entity Close Management System

FIG. 1 is an overall block diagram of an enhanced automated entity close process management system 100, according to one example.

As shown, the enhanced automated entity close process management system 100 includes an entity close modeling engine 120, which can communicate with a task library 140 and a display 150. The entity close modeling engine 120 includes a task editor 122, a task sequence builder 124, a user interface 126, a task status manager 128, and at least one entity close scheme 130. At least one task executor 160 can communicate with the entity close scheme 150. The at least one task executor 160 can access a database 170 maintaining data pertaining to the entity close (e.g., financial transactions, taxes, resources, etc.). A user 110 can interact with the entity close modeling engine 120 through the user interface 126.

For example, the user 110 can use the task editor 122 to create and edit one or more task objects. Each task object represents a task that needs to be executed for the automated entity close process. As described further below, each task object can include a plurality of task properties, including a planned task start time, a planned duration, and other task-specific parameters, such as task identifier (ID), task status, assigned personnel responsible for the task, etc. In some circumstances, the user 110 can create new task objects based on predefined task templates stored in the task library 140. In some circumstances, the user 110 can create a new task object by first duplicating an existing task object and then editing the duplicated task object.

FIG. 2 depicts an example user interface 200 (e.g., an embodiment of 126 shown on the display 150) which shows a list of task objects 210, each of which has a plurality of properties (e.g., task description, planned duration, task ID, task type, etc.) that can be defined or specified. The user 110 can select one or more of the listed task objects 210 to change their properties. For example, the user can select one or more task properties 220 associated with the selected task objects 210 for editing. To illustrate, FIG. 3 shows an example user interface 300 (e.g., an embodiment of 126 shown on the display 150) having a pop-up window 310 which allows the user 110 to change the planned start time for previously selected task objects 210.

In certain examples, the user 110 can use the task sequence builder 124 to edit dependencies between task objects to build one or more task sequences. In certain examples, the dependency between task objects can be defined by a predecessor-successor relationship, where the start of a successor task object is allowed only after the completion of a predecessor task object. To illustrate, FIG. 4 shows an example user interface 400 (e.g., an embodiment of 126 shown on the display 150) which allows the user 110 to define dependencies between task objects. For example, for each task object, the user 110 can define its predecessor task objects 420 and/or successor task objects 430 by choosing from a list of available task objects 410.

In some examples, each task object can have zero, one, or more predecessor task objects. In some examples, each task object can have zero, one, or more successor task objects. While a typical task sequence may include two or more task objects having specified predecessor-successor relationship, a single task object having neither a predecessor nor a successor can also be deemed as a special case of task sequence.

In some examples, the task sequence builder 124 is configured to automatically perform a sanity check to ensure the user-specified predecessor-successor relationship is valid. For example, the task sequence builder 124 can generate warnings/errors to the use if the predecessor-successor relationship defined in a sequence includes a cycle (i.e., the execution of the task objects could otherwise lead to an endless loop).

The collection of task objects and task sequences can be referred to as an entity close scheme or schedule 130. In some examples, the created entity close scheme 130 can be stored in the database 170. In some examples, any changes to the entity close scheme 130 in the entity close modeling engine 120 can cause corresponding update of the entity close scheme 130 stored in the database 170. In some examples, instead of creating an entity close scheme 130 from scratch, the user 110 can retrieve from the database 170 a previously stored entity close scheme, use it as a template, and then use the task editor 122 and/or the task sequence builder 124 to edit such template to generate the desired entity close scheme.

The entity close scheme 130 can be graphically represented on the display 150 as a directed graph in which task objects can be represented as nodes and dependencies between task objects can be represented by directional edges connecting the corresponding task objects. As described below, the entity close scheme 130 can be associated with a closing target time, which can be automatically determined based on the task objects included in the entity close scheme 130 or defined by the user 110 (e.g., via the user interface 126). The closing target time represents a deadline by which time the automated entity close process represented by the entity close scheme 130 must be completed.

As an example, FIG. 5 depicts a graphical user interface 500 (e.g., an embodiment of 126 shown on the display 150) which shows an example entity close scheme 510 (e.g., an embodiment of 130). As the whole entity close scheme 510 can include hundreds or thousands of task objects and/or task sequences, the user can choose to view only a selected portion 520 of the entity close scheme 510, e.g., by zooming and/or panning the entity close scheme 510. As illustrated in FIG. 5, each task object can be represented by a rectangular (or other shaped) node, on which selected property information (e.g., object description, task ID, task status, etc.) can be displayed. The dependencies between task objects can be represented by directed arrows.

As described herein, the task status of a task object reflects the execution status of the task object. For example, the execution status of a task object can be “not started,” “in progress,” “completed without errors,” “completed with warnings,” “completed with errors,” etc. In certain examples, the displayed task objects can be color coded (or through other visually distinguishable features such as shade/fill patterns, border types, displayed fonts, or the like) to provide visual indications of their corresponding task status.

During the automated entity close process, task objects in the entity close scheme 510 are executed. Execution of the task objects can be performed by one or more task executors 160. Some task executors 160 can be software applications configured to execute certain task objects automatically (e.g., calculating asset depreciations, converting currencies based on foreign exchange rate, generating financial reports, etc.). Some task executors 160 can involve manual operations. Execution of the task objects by the task executors 160 can involve accessing data stored in the database 170. For example, at the start of a task object, the task executor 160 can retrieve relevant financial data resource information stored in the database 170. As another example, upon the completion of a task object, data relevant to the task object can be updated in the database 170 (e.g., updating relevant financial records, releasing resources assigned to the task object, etc.).

The task status of each task object can be monitored, for example, by the task status manager 128. In some examples, the task status of a task object can be automatically changed by a running software (e.g., an application run by the task executor 160, etc.) in communication with the task status manager 128. In some examples, the user 110 can manually change the task status of a selected task object through the graphical user interface 500 (e.g., by double clicking the selected task object to open an editor to change the task status of the selected task object, or the like). In some examples, the task status of each task object can be stored and updated in the database 170.

As described herein, some of the task sequences can be determined to be target critical sequences. Additionally, at least one of the task sequences can be determined to be longest sequence. The method of identifying the target critical sequences and longest sequence is described more fully below. In certain examples, the user 110 can select displaying only target critical sequences (e.g., by clicking a “Critical Sequences” button 530) and/or the longest sequence (e.g., by clicking a “Longest Sequence” button 540). In certain examples, task objects included in the target critical sequences and longest sequence can be highlighted using visually distinctive features (e.g., colors, shade/fill patterns, border types, displayed fonts, or the like).

Returning to FIG. 1, the user 110 can perform enhanced entity close modeling by interacting with the entity close modeling engine 120. Specifically, through the user interface 126, the user 110 can explore opportunities to optimize the automated entity close process by simulating changes to the entity close scheme 130, e.g., by changing planned start times and/or durations of certain tasks, and/or by changing the closing target time associated with the entity close scheme 130. Responsive to the simulated changes to the entity close scheme 130, the target critical sequences and the longest sequence can be updated on the display 150. If the user 110 is satisfied with the simulated results, the user 110 can accept the simulated changes, thereby updating the entity close scheme 130.

Additionally, during execution of the entity close scheme 130, changes in the task status of certain task objects (e.g., detected by the task status manager 128) may prompt the user 110 to adjust the entity close scheme 130 (e.g., via the user interface 126) on the fly, for example, by changing the planned start times and/or durations of certain task objects, and/or changing the closing target time associated with the entity close scheme 130. Likewise, adjustment to the entity close scheme 130 can cause update of the target critical sequences and the longest sequence on the display 150.

In practice, the systems shown herein, such as the system 100, can vary in complexity, with additional functionality, more complex components, and the like. For example, there can be additional functionality within the entity close modeling engine 120. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the tasks, task sequences, closing target time, or the like can be stored in one or more computer-readable storage media or computer-readable storage devices. The technologies described herein can be generic to the specifics of operating systems or hardware and can be applied in any variety of environments to take advantage of the described features.

### Example 3—Example Overall Method for Enhanced Entity Close Modeling

FIG. 6 is a flowchart of an example overall method 600 for enhanced entity close modeling, and can be implemented, for example, by the enhanced automated entity close process management system of FIG. 1.

At 610, an entity close scheme (e.g., 130) can be presented on a display window (e.g., 150). As described above, the entity close scheme can include a plurality of task sequences, and each task sequence can include one or more task objects with respective planned start times and durations. In some examples, the entity close scheme can be generated by the user through the entity close modeling engine 120. In some examples, the entity close modeling engine 120 can receive the entity close scheme from another source.

At 620, a closing target time for the entity close scheme can be marked on the display window. In some examples, the closing target time can be manually defined by a user. In some examples, the closing target time can be automatically determined based on the task objects included in the entity close scheme, as described further below.

At 630, the method 600 can highlight, on the display window, target critical sequences from the plurality of task sequences based on the closing target time and a predefined offset duration. Example methods of determining the target critical sequences are described further below. In some examples, such highlighting can be effectuated, e.g., by clicking a control element (e.g., the “Critical Sequences” button 530) such that only the target critical sequences are shown on the display window. In some examples, the highlighting can be implemented by presenting the task objects in the target critical sequences using visually distinctive features (e.g., shade/fill patterns, border types, displayed fonts, or the like).

At 640, the method 600 can highlight, on the display window, a longest sequence from the plurality of task sequences based on the start times and durations of the task objects included in the plurality of task sequences. Example methods of determining the longest sequence are described further below. In some examples, such highlighting can be effectuated, e.g., by clicking a control element (e.g., the “Longest Sequence” button 540) such that only the longest sequence is shown on the display window. In some examples, the highlighting can be implemented by presenting the task objects in the longest sequence using visually distinctive features (e.g., shade/fill patterns, border types, displayed fonts, or the like).

At 650, through a user interface (e.g., 126), the user can simulate a change to the entity close scheme. As described above and illustrated further below, such simulation can include changing the planned start times and/or durations of certain task objects, and/or changing the closing target time associated with the entity close scheme.

Then, at 660, responsive to the simulated change, the target critical sequences and the longest sequence can be updated (and highlighted) on the display window.

The method 600 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 4—Example Entity Close Scheme

FIG. 7 schematically depicts an example entity close scheme 700, which includes a plurality of task objects (represented by rectangular boxes) arranged in three task sequences 710, 720, and 730. The task sequence 710 includes four task objects arranged in two subsequences: one subsequence includes task objects 712, 714, and 716; another subsequence includes task objects 712 and 718 (i.e., both task objects 714 and 718 are successors of task object 712). The task sequence 720 also includes two subsequences: one subsequence includes task objects 722, 724, and 728; another subsequence includes task objects 722, 726, and 728 (i.e., both task objects are successors of task object 722 and predecessors of task object 728). The task sequence 730 includes three task objects 732, 734, and 736.

As described above, each task object can have a planned start time and planned duration. Thus, the planned completion time of each task object can be calculated by adding the planned duration and the planned start time of that task object. In the depicted example, the horizontal axis is the time axis. The left boundary of each task object indicates the planned start time of that task object, the width of each task object represents the planned duration of that task object, and the right boundary of each task object indicates the planned completion time of that task object. Notably, the planned start time of a successor task can be delayed (i.e., having a time gap) compared to the planned completion time of its predecessor. Such delays or time gaps can be due to a variety of reasons, e.g., due to weekends and/or holidays or other scheduling constraints that prevent a successor from immediately starting after the completion of its predecessor.

For each task sequence, a sequence start time and a sequence end time can be determined. The sequence start time for a task sequence is determined based on the planned start time of a first task object in the task sequence. The sequence end time for a task sequence is determined based on the planned completion time of a last task object in the task sequence. For example, the sequence start time of task sequence 730 is the planned start time of task object 732, and the sequence end time of task sequence 730 is the planned completion time of task object 736. Similarly, the sequence start time of task sequence 710 is the planned start time of task object 712, and the sequence end time of task sequence 710 is the planned completion time of task object 716 (assuming it is later than the planned completion time of task object 718).

FIG. 7 also marks several time points and durations associated with the entity close scheme 700. For example, the dotted line 770 marks the overall start time of the entity close scheme 700. As described herein, the overall start time 770 represents the earliest sequence start time of all task sequences. In the depicted example, the sequence start time of task sequence 730 (also the planned start time of task object 732) defines the overall start time 770. The dotted line 760 marks a key date which can be predefined for the entity close scheme 700. The key date 760 represents a time point (e.g., the last day of a fiscal year) when all financial postings must be executed and required financial books must be closed, while certain post-closing activities (e.g., data cleanup and/or correction to prepare for the next fiscal period, etc.) can continue. For example, the tasks represented by task objects 714, 716, 718, 728, and 736 can continue even after passing the key date 760).

The dashed line 740 marks a closing target time which represents a deadline when all closing activities in the entity close scheme 700 must stop. In certain examples, the closing target time 740 can be automatically determined, e.g., the closing target time 740 can be determined as the latest sequence end time of all task sequences. In the depicted example, the closing target time 740 is the sequence end time of task sequence 710 (also the planned completion time of task object 716). In some examples, the closing target time 740 can be manually defined by the user. When manually defined, the closing target time 740 can be later than (but not earlier than) the latest sequence end time of all task sequences.

The dashed line 750 marks a threshold time which precedes the closing target time 740 by a predefined offset duration A. Depending on the circumstances, the offset duration A can be set to a number of days, or a number of hours, or a number of minutes. In certain circumstances, both the closing target time 740 and the threshold time 750 can be deemed part of the entity close scheme 700, and can be defined by the user. As described herein, the threshold time 750 can be used to determine target critical sequences. Specifically, a task sequence is identified as a target critical sequence if its sequence end time is later than the threshold time 750. In other words, a target sequence is deemed to be critical if the planned completion time of its last task object is sufficiently close to the closing target time 740 (e.g., less than the offset duration A). In the depicted example, the task sequence 710 is identified as a target critical sequence because its sequence end time (also the planned completion time of task object 716) is later than the threshold time 750. In contrast, both target sequences 720 and 730 are not target critical sequences because their corresponding sequence end times are earlier than the threshold time 750.

Thus, if the closing target time 740 is automatically determined, e.g., based on the latest sequence end time of all task sequences, at least one task sequence (having the latest sequence end time) can be identified as the target critical sequence. On the other hand, if the closing target time 740 is manually set by the user, then it is possible that no task sequence is identified as the target critical sequence. As described above, the identified target critical sequences (e.g., 710) can be highlighted on the display window.

As described herein, the longest sequence of an entity close scheme can be determined by calculating total durations for the plurality of task sequences included in the entity close scheme based on corresponding sequence start times and sequence end times, and finding a maximum of the total durations for the plurality of task sequences. In the depicted example, the task sequence 730 can be identified as the longest sequence because its total duration LD (measured from its sequence start time to its sequence end) is longer than the total durations of task sequences 710 and 720. Notably, the total duration LD of task sequence 730 is the sum of the durations of task objects 732, 734, and 736, as well as the time gaps therebetween. As described above, the identified longest sequence (e.g., 730) can be highlighted on the display window.

FIG. 7 also marks the overall duration (OD) of the entity close scheme 700 which measures the duration from the earliest sequence start time of all task sequences (e.g., the sequence start time of task sequence 730) to the latest sequence end time of all task sequences (e.g., the sequence end time of task sequence 710).

### Example 5—Example Methods of Optimizing an Entity Close Scheme

As described above, a user can simulate a change to the entity close scheme in order to optimize the entity close scheme, e.g., to reduce the overall duration of the entity close scheme while ensuring the entity close is completed before a specified closing target time. Changing the entity close scheme can cause corresponding changes to the target critical sequences and/or the longest sequence. In any of the examples described herein, the updated target critical sequences and/or the longest sequence can be highlighted on the display window. If the user is satisfied with the simulated results, the user can accept the simulated changes, thereby updating the entity close scheme. FIGS. 8-10 illustrate various approaches a user can take to optimize the entity close scheme 700 depicted in FIG. 7.

In certain examples, the user can change the planned start times and/or durations of one or more task objects. Such changes can be made, for example, if the user allocates additional resources to certain task objects, reprioritizes task objects assigned to certain personnel or user groups, and/or adjusts time gaps between task objects. In the example depicted in FIG. 8, the user reduces the durations of task objects 714 and 716, and also moves ahead the planned start time of task object 716. Such changes can be made through a user interface (e.g., 126), as described above. As a result, the sequence end time of task sequence 710 is changed to the planned completion time of task object 718 (instead of the planned completion time of task object 716). Accordingly, the entity close scheme 700 is changed to 700′. In this example, the task sequence 710 remains as the target critical sequence because the sequence end time of task sequence 710 is still later than the threshold time 750. The task sequence 730 still remains as the longest sequence. However, the overall duration (OD) of the entity close scheme 700′ can be potentially reduced compared to that of 700.

To actually reduced the overall duration of the entity close scheme 700′, the user has an option to postpone the planned start times of one or more task objects. In a specific example, FIG. 9 shows that the user can postpone the planned start times of all task objects to the same extend (e.g., t1) such that the sequence end time of the target critical sequence 710 coincides (or substantially coincides) with the closing target time 740. As a result, the overall start time 770 is postponed by a duration t1 (as indicated by the block arrow 772). Thus, even if the entity close scheme 700′ is started late (compared to 700), the entity close scheme 700′ is still projected to be completed at or before the closing target time 740. In other words, the overall duration for the entity close scheme is reduced.

Generally, if it is determined that the longest sequence is not a target critical sequence (e.g., 730 in FIG. 8), the longest sequence can be converted to a target critical sequence (e.g., 730 in FIG. 9), e.g., by postponing its sequence start time such that its sequence end time moves closer to the closing target time. Such conversion can reduce the overall duration of the entity close scheme if the sequence start time of the longest sequence is also the overall start time of the entity close scheme.

FIG. 10 illustrates another option the user can take to reduce the overall duration of the entity close scheme 700′. In this example, instead of postponing the overall start time 770, the user can advance the closing target time 740 (as indicated by the block arrow 742) by a duration t2 (which can be the same as t1) so that the closing target time 740 coincides (or substantially coincides) with the sequence end time of the target critical sequence 710. In other words, without changing the overall start time 770, the closing target time 740 can be moved ahead. The threshold time 750 can also be advanced (as indicated by the block arrow 752) to the same extend (e.g., t2). As a result, the longest sequence 730 also becomes a target critical sequence because its sequence end time is also past the threshold time 750. Thus, the entity close scheme 700′ has two target critical sequences 710 and 730. As described herein, changing the closing target time 740 and/or the threshold time 750 can be performed by the user through a user interface (e.g., 126). In certain examples, the closing target time 740 and/or the threshold time 750 can be changed directly on the display window (e.g., by dragging corresponding time markers by a pointing device such as a mouse, a stylus, etc.).

Identification (and highlighting) the target critical sequences can alert the user task objects that are critical to maintain planned start times and durations in order to complete the entity close scheme before the closing target time. During execution of the entity close scheme, changes in the start times and/or durations of certain task objects (e.g., which can be detected by the task status manager 128) can cause corresponding update of the target critical sequences and/or the longest sequence. For instance, the delay of one particular task object 728 in FIG. 7 may cause the task sequence 720 to become a task critical sequence (e.g., the planned completion time of task object 728 pasts the threshold time 750), and/or even becomes the longest sequence (e.g., if the total duration of the task sequence 720 is longer than that of task sequence 730).

The user may respond to such changes by adjusting the entity close scheme (e.g., via the user interface 126), for example, by changing the planned start times and/or durations of certain task objects. Additionally, and/or alternatively, the user can change the overall start time and/or the closing target time associated with the entity close scheme, as described above.

### Example 6—Example Advantages

A number of advantages can be achieved via the technologies described herein. As described above, an entity close scheme can be extremely convoluted such that a user may miss the opportunities to optimize the entity close scheme during both the planning phase and the execution phase (e.g., due to positive deviations of certain task objects), and/or risk undesirable delays in entity close (e.g., due to negative deviations of certain task objects). The enhanced automated entity close process management system described herein provides an interactive software tool which enables the users to optimize an entity close scheme during both planning and execution phases of the entity close. Specifically, using this tool, the user can quickly identify task critical sequences and the longest sequence, which can be dynamically updated during execution of relevant task objects. Thus, the user not only can optimize the entity close scheme when planning the entity close, but also can react quickly to adjust the entity close scheme when actual execution of certain tasks deviates (either positively or negatively) from what has been planned. Such adjustment of the entity close scheme during the execution phase of entity close allows the user to dynamically optimize the entity close scheme on the fly, e.g., to reduce the overall execution time of the entity close (and thus the associated cost), and/or avoid running the entity close behind the deadline (e.g., the closing target time) due to unexpected delays of certain task objects. As described above, optimization of the entity close scheme can also potentially allow advancement of the closing target time, thus enabling organizations to report their status (e.g., financials, etc.) earlier and react earlier to such status.

### Example 7—Example Computing Systems

FIG. 11 depicts an example of a suitable computing system 1100 in which the described innovations can be implemented. The computing system 1100 is not intended to suggest any limitation as to scope of use or functionality of the present disclosure, as the innovations can be implemented in diverse computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 can execute computer-executable instructions, such as for implementing the features described in the examples herein (e.g., the method 600, etc.). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 11 shows a central processing unit 1110 as well as a graphics processing unit or co-processing unit 1115. The tangible memory 1120, 1125 can be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 can store software 1180 implementing one or more innovations described herein, in the form of computer-executable instructions suitable for execution by the processing unit(s) 1110, 1115.

A computing system 1100 can have additional features. For example, the computing system 1100 can include storage 1140, one or more input devices 1150, one or more output devices 1160, and one or more communication connections 1170, including input devices, output devices, and communication connections for interacting with a user. An interconnection mechanism (not shown) such as a bus, controller, or network can interconnect the components of the computing system 1100. Typically, operating system software (not shown) can provide an operating environment for other software executing in the computing system 1100, and coordinate activities of the components of the computing system 1100.

The tangible storage 1140 can be removable or non-removable, and includes magnetic disks, magnetic tapes or cassettes, CD-ROMs, DVDs, or any other medium which can be used to store information in a non-transitory way and which can be accessed within the computing system 1100. The storage 1140 can store instructions for the software 1180 implementing one or more innovations described herein.

The input device(s) 1150 can be an input device such as a keyboard, mouse, pen, or trackball, a voice input device, a scanning device, touch device (e.g., touchpad, display, or the like) or another device that provides input to the computing system 1100. The output device(s) 1160 can be a display, printer, speaker, CD-writer, or another device that provides output from the computing system 1100.

The communication connection(s) 1170 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Example 8—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 9—Example Cloud Computing Environment

FIG. 12 depicts an example cloud computing environment 1200 in which the described technologies can be implemented, including, e.g., the system 600 and other systems herein. The cloud computing environment 1200 can include cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 can be utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operations (e.g., data processing, data storage, and the like).

In practice, cloud-based, on-premises-based, or hybrid scenarios can be supported.

### Example 10—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example 11—Example Embodiments

Any of the following example embodiments can be implemented.

Example 1. A computing system for enhanced entity close modeling, comprising: memory; one or more hardware processors coupled to the memory; and one or more computer readable storage media storing instructions that, when loaded into the memory, cause the one or more hardware processors to perform operations comprising: presenting, on a display window, an entity close scheme comprising a plurality of task sequences, wherein a task sequence comprises one or more task objects with respective start times and durations; marking, on the display window, a closing target time for the entity close scheme; highlighting, on the display window, target critical sequences from the plurality of task sequences based on the closing target time and a predefined offset duration; highlighting, on the display window, a longest sequence from the plurality of task sequences based on the start times and durations of the task objects included in the plurality of task sequences; simulating, through a user interface, a change to the entity close scheme; and responsive to the simulated change, updating the target critical sequences and the longest sequence on the display window.

Example 2. The system of example 1, wherein the operations further comprise determining a plurality of sequence start times and sequence end times for the plurality of task sequences, wherein the sequence end time for a task sequence is determined based on the start time and duration of a last task object in the task sequence, wherein the sequence start time for a task sequence is determined based on the start time of a first task object in the task sequence.

Example 3. The system of example 2, wherein the marking the closing target time comprises finding a latest sequence end time from the plurality of sequence end times.

Example 4. The system of any one of examples 2-3, wherein the highlighting target critical sequences comprises comparing the plurality of sequence end times with the closing target time minus the offset duration.

Example 5. The system of any one of examples 2-4, wherein the highlighting the longest sequence comprises calculating total durations for the plurality of task sequences based on the plurality of sequence start times and sequence end times, and finding a maximum of the total durations for the plurality of task sequences.

Example 6. The system of any one of examples 1-5, wherein the simulating comprises changing the start times of one or more task objects through the user interface.

Example 7. The system of any one of examples 1-6, wherein the simulating comprises changing the durations of one or more task objects through the user interface.

Example 8. The system of any one of examples 1-7, wherein the simulating comprises changing the closing target time through the user interface.

Example 9. The system of any one of examples 1-8, wherein the operations further comprise: monitoring execution status of the entity close scheme, wherein the monitoring comprises detecting a change to the start time and/or duration of at least one task object; and responsive to detecting the change, updating the target critical sequences and the longest sequence on the display window.

Example 10. A computer-implemented method for enhanced entity close modeling, the method comprising: presenting, on a display window, an entity close scheme comprising a plurality of task sequences, wherein a task sequence comprises one or more task objects with respective start times and durations; marking, on the display window, a closing target time for the entity close scheme; highlighting, on the display window, target critical sequences from the plurality of task sequences based on the closing target time and a predefined offset duration; highlighting, on the display window, a longest sequence from the plurality of task sequences based on the start times and durations of the task objects included in the plurality of task sequences; simulating, through a user interface, a change to the entity close scheme; and responsive to the simulated change, updating the target critical sequences and the longest sequence on the display window.

Example 11. The method of example 10, further comprising determining a plurality of sequence start times and sequence end times for the plurality of task sequences, wherein the sequence end time for a task sequence is determined based on the start time and duration of a last task object in the task sequence, wherein the sequence start time for a task sequence is determined based on the start time of a first task object in the task sequence.

Example 12. The method of example 11, wherein the marking the closing target time comprises finding a latest sequence end time from the plurality of sequence end times.

Example 13. The method of any one of examples 11-12, wherein the highlighting target critical sequences comprises comparing the plurality of sequence end times with the closing target time minus the offset duration.

Example 14. The method of any one of examples 11-13, wherein the highlighting the longest sequence comprises calculating total durations for the plurality of task sequences based on the plurality of sequence start times and sequence end times, and finding a maximum of the total durations for the plurality of task sequences.

Example 15. The method of any one of examples 10-14, wherein the simulating comprises changing the start times of one or more task objects through the user interface.

Example 16. The method of any one of examples 10-15, wherein the simulating comprises changing the durations of one or more task objects through the user interface.

Example 17. The method of any one of examples 10-16, wherein the simulating comprises changing the closing target time through the user interface.

Example 18. The method of any one of examples 10-17, further comprising: monitoring execution status of the entity close scheme, wherein the monitoring comprises detecting a change to the start time and/or duration of at least one task object; and responsive to detecting the change, updating the target critical sequences and the longest sequence on the display window.

Example 19. One or more non-transitory computer-readable media having encoded thereon computer-executable instructions causing one or more processors to perform a method for enhanced entity close modeling, comprising: presenting, on a display window, an entity close scheme comprising a plurality of task sequences, wherein a task sequence comprises one or more task objects with respective start times and durations; determining a plurality of sequence start times and sequence end times for the plurality of task sequences; marking, on the display window, a closing target time for the entity close scheme; highlighting, on the display window, target critical sequences from the plurality of task sequences based on the closing target time and a predefined offset duration; highlighting, on the display window, a longest sequence from the plurality of task sequences based on the start times and durations of the task objects included in the plurality of task sequences; simulating, through a user interface, a change to the entity close scheme; and responsive to the simulated change, updating the target critical sequences and the longest sequence on the display window, wherein the sequence end time for a task sequence is determined based on the start time and duration of a last task object in the task sequence, wherein the sequence start time for a task sequence is determined based on the start time of a first task object in the task sequence, wherein the marking the closing target time comprises finding a latest sequence end time from the plurality of sequence end times, wherein the simulating comprises changing the closing target time through the user interface.

Example 20. The one or more non-transitory computer-readable media of example 19, wherein the simulating comprises changing the start times and/or durations of one or more task objects through the user interface.

### Example 12—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system for enhanced entity close modeling, comprising:
memory;
one or more hardware processors coupled to the memory; and
one or more computer readable storage media storing instructions that, when loaded into the memory, cause the one or more hardware processors to perform operations comprising:
presenting, on a display window, an entity close scheme comprising a plurality of task sequences, wherein a task sequence comprises one or more task objects with respective start times and durations;
marking, on the display window, a closing target time for the entity close scheme;
highlighting, on the display window, target critical sequences from the plurality of task sequences based on the closing target time and a predefined offset duration;
highlighting, on the display window, a longest sequence from the plurality of task sequences based on the start times and durations of the task objects included in the plurality of task sequences;
simulating, through a user interface, a change to the entity close scheme; and
responsive to the simulated change, updating the target critical sequences and the longest sequence on the display window.

2. The system of claim 1, wherein the operations further comprise determining a plurality of sequence start times and sequence end times for the plurality of task sequences, wherein the sequence end time for a task sequence is determined based on the start time and duration of a last task object in the task sequence, wherein the sequence start time for a task sequence is determined based on the start time of a first task object in the task sequence.

3. The system of claim 2, wherein the marking the closing target time comprises finding a latest sequence end time from the plurality of sequence end times.

4. The system of claim 2, wherein the highlighting target critical sequences comprises comparing the plurality of sequence end times with the closing target time minus the offset duration.

5. The system of claim 2, wherein the highlighting the longest sequence comprises calculating total durations for the plurality of task sequences based on the plurality of sequence start times and sequence end times, and finding a maximum of the total durations for the plurality of task sequences.

6. The system of claim 1, wherein the simulating comprises changing the start times of one or more task objects through the user interface.

7. The system of claim 1, wherein the simulating comprises changing the durations of one or more task objects through the user interface.

8. The system of claim 1, wherein the simulating comprises changing the closing target time through the user interface.

9. The system of claim 1, wherein the operations further comprise:
monitoring execution status of the entity close scheme, wherein the monitoring comprises detecting a change to the start time and/or duration of at least one task object; and
responsive to detecting the change, updating the target critical sequences and the longest sequence on the display window.

10. A computer-implemented method for enhanced entity close modeling, the method comprising:
presenting, on a display window, an entity close scheme comprising a plurality of task sequences, wherein a task sequence comprises one or more task objects with respective start times and durations;
marking, on the display window, a closing target time for the entity close scheme;
highlighting, on the display window, target critical sequences from the plurality of task sequences based on the closing target time and a predefined offset duration;
highlighting, on the display window, a longest sequence from the plurality of task sequences based on the start times and durations of the task objects included in the plurality of task sequences;
simulating, through a user interface, a change to the entity close scheme; and
responsive to the simulated change, updating the target critical sequences and the longest sequence on the display window.

11. The method of claim 10, further comprising determining a plurality of sequence start times and sequence end times for the plurality of task sequences, wherein the sequence end time for a task sequence is determined based on the start time and duration of a last task object in the task sequence, wherein the sequence start time for a task sequence is determined based on the start time of a first task object in the task sequence.

12. The method of claim 11, wherein the marking the closing target time comprises finding a latest sequence end time from the plurality of sequence end times.

13. The method of claim 11, wherein the highlighting target critical sequences comprises comparing the plurality of sequence end times with the closing target time minus the offset duration.

14. The method of claim 11, wherein the highlighting the longest sequence comprises calculating total durations for the plurality of task sequences based on the plurality of sequence start times and sequence end times, and finding a maximum of the total durations for the plurality of task sequences.

15. The method of claim 10, wherein the simulating comprises changing the start times of one or more task objects through the user interface.

16. The method of claim 10, wherein the simulating comprises changing the durations of one or more task objects through the user interface.

17. The method of claim 10, wherein the simulating comprises changing the closing target time through the user interface.

18. The method of claim 10, further comprising:
monitoring execution status of the entity close scheme, wherein the monitoring comprises detecting a change to the start time and/or duration of at least one task object; and
responsive to detecting the change, updating the target critical sequences and the longest sequence on the display window.

19. One or more non-transitory computer-readable media having encoded thereon computer-executable instructions causing one or more processors to perform a method for enhanced entity close modeling, comprising:
presenting, on a display window, an entity close scheme comprising a plurality of task sequences, wherein a task sequence comprises one or more task objects with respective start times and durations;
determining a plurality of sequence start times and sequence end times for the plurality of task sequences;
marking, on the display window, a closing target time for the entity close scheme;
highlighting, on the display window, target critical sequences from the plurality of task sequences based on the closing target time and a predefined offset duration;
highlighting, on the display window, a longest sequence from the plurality of task sequences based on the start times and durations of the task objects included in the plurality of task sequences;
simulating, through a user interface, a change to the entity close scheme; and
responsive to the simulated change, updating the target critical sequences and the longest sequence on the display window,
wherein the sequence end time for a task sequence is determined based on the start time and duration of a last task object in the task sequence, wherein the sequence start time for a task sequence is determined based on the start time of a first task object in the task sequence,
wherein the marking the closing target time comprises finding a latest sequence end time from the plurality of sequence end times,
wherein the simulating comprises changing the closing target time through the user interface.

20. The one or more non-transitory computer-readable media of claim 19, wherein the simulating comprises changing the start times and/or durations of one or more task objects through the user interface.
